(19) United States
(12) Patent Application Publication
(10) Pub. No.: US 2023/0365338 A1
(43) Pub. Date: Nov. 16, 2023

(54) FASTENING SYSTEM FOR A HOOD FOR PROTECTING CONVEYOR BELTS

(71) Applicant: COMPAÑÍA CONTRACTUAL MINERA CANDELARIA, Santiago (CL)

(72) Inventors: Rodrigo Ignacio IRIARTE RODRÍGUEZ, Copiapó (CL); Alejandro Alberto SEGURA PEREIRA, Coquimbo (CL); Miguel Alejandro TORRES PASTEN, La Serena (CL); Guido Mauricio GRAGO LOPEZ, Coquimbo (CL); Joel Francisco Javier BARRAZA SOTO, Coquimbo (CL)

(21) Appl. No.: 18/029,238

(22) PCT Filed: Sep. 29, 2021
(86) PCT No.: PCT/CL2021/050094

§ 371 Date: Mar. 29, 2023

(30) Foreign Application Priority Data
Sep. 30, 2020 (CL) 2534-2020

(51) Int. Cl. B65G 21/08

(52) U.S. Cl. CPC B65G 21/08

(57) ABSTRACT

This invention relates to a fastening system (100) for a hood for protecting conveyor belts, which takes advantage of the strength and elasticity of the hood material for fastening to a conveyor belt structure (200), comprising: a hood (1) comprising ends of the hood (1) configured by a folding portion (4); a vertical/horizontal fastening comprising a rail (101), which is arranged longitudinally on each side of the structure (200), which engages with the folding portion (4) of the end of the cover; and a fastening comprising a plurality of latches (103) arranged on the folding portion (4) of the hood (1), for the fastening thereof to the rail (101).

### FIELD OF APPLICATION

This utility model is related to a hood for conveyor belts in order to generate a light and resistant encapsulated system.

### BACKGROUND

Conveyor belts have become an essential piece of equipment in industrial tasks that require the transport of material from one place to another, particularly when the distances to be covered are substantially long. Due to these distances, in most industrial activities, conveyor belts are exposed to environmental conditions, such as wind, humidity and temperature, which could affect the material being transported. For this reason, protective covers have been designed to be installed over the conveyor belts, in order to protect the material being transported, as well as to protect the conveyor belt from any damage it may suffer. Generally, covers are made of plastic and metal materials.

One of the problems related to this type of covers is their assembly on conveyor belts or transport units. Different solutions have been proposed by the state of the art regarding this type of covers. DE10200892 describes a system for holding the hood of a ladder comprising, on the one hand, a brace attached to a hook and, on the other hand, a brace attached to a handle with a similar hook at its base. The handle contains a compression spring held between the hooked ends of two interlocking V-shaped frames.

Another solution is disclosed by KR2020200000016, which describes a cover device for a conveyor belt, which can cover the upper side of a conveyor belt; a fastening piece installed on the outer surface of the cover piece to maintain a state in which the cover piece is stably installed; wherein the fastening piece comprises: a clamp piece installed at both ends of the fastening piece to maintain a state in which the fastening piece is tightly tensioned; and an assembly piece attached to the conveyor belt frame to maintain a state in which the cover piece is stably installed by installing the fastening piece at regular intervals on the outer surface of the cover piece.

WO2017012985 describes a covered belt conveyor comprising a belt; a case; a base frame having a first longitudinal rail and a second longitudinal rail; and a frame. The cover defines an inner zone inside the cover and a secure outer zone outside the cover, wherein the frame is attached to the base frame at an outer box region outside the cover so that the frame can be adjusted during operation of the belt conveyor cover without entering the inner region inside the cover.

However, such solutions are still complex to install. Most of the conveyor equipment is largely suspended in terms of its structure, so the handling of smaller items must be done through the available aisles, and for heavier and larger items, the use of lifting equipment is required. Therefore, it is very important that the weight be as low as possible to allow handling by personnel in the aisles, without risking their safety.

### SUMMARY OF THE INVENTION

This utility model is related to a hood for conveyor belts comprising a quick-drive fastening system which takes advantage of the strength and elasticity of the hood material achieved by the manufacturing technique.

The fastening system means that the hood does not use bolts for fastening, but uses a longitudinal female-male fastening and for vertical/horizontal fastening, it uses a rail attached to the belt table. This reduces the time for assembling and disassembling each unit and furthermore only requires two people. This represents a huge time and safety advantage over traditional metal encapsulations. Furthermore, the seal between each hood or cover allows each element to be removed individually without the need to remove adjacent elements and this is achieved without additional support structures.

With the hood of this utility model, a reduced weight is achieved, which reduces the risk of accidents and does not have a negative impact on the operation and maintenance activities of the equipment. Moreover, considerable savings in time and resources are made for maintenance and operation activities since no lifting equipment is required for the removal and disassembly of the encapsulation and the time for assembling and disassembling each element does not exceed one minute.

### DESCRIPTION OF THE FIGURES

FIG. 1 shows a top perspective view of the hood disposed over the conveyor belt structure in operation, according to one embodiment of the invention.

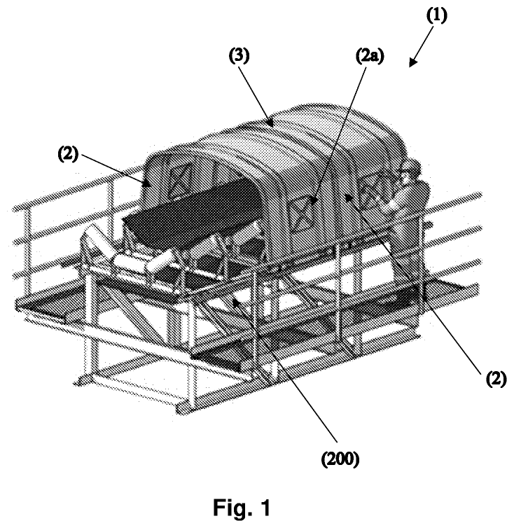

FIG. 2 shows a top perspective view of the windowless hood disposed over the conveyor belt structure in operation, according to one embodiment of the invention.

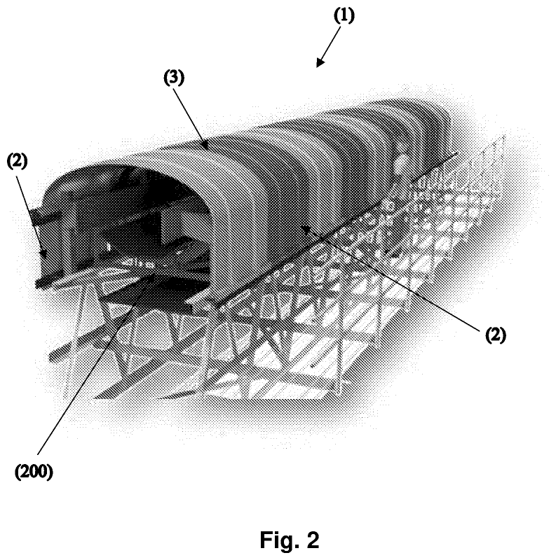

FIG. 3 shows a perspective view of a detail of a portion of the hood during operation, according to one embodiment of the invention.

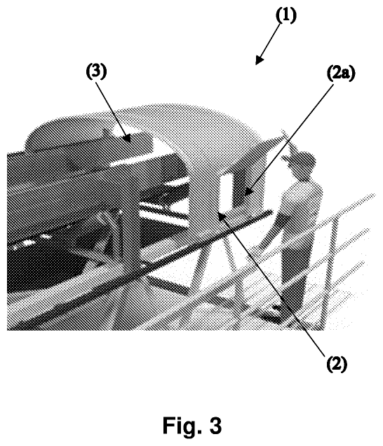

FIG. 4 shows a perspective view of a detail of a portion of the hood with flat side walls, according to one embodiment of the invention.

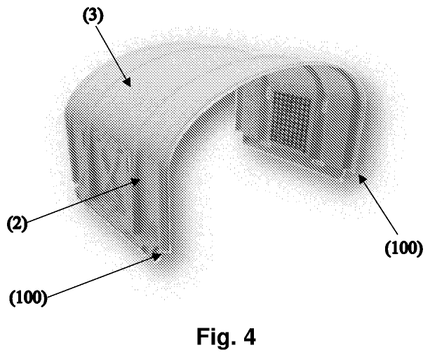

FIG. 5 shows a perspective view of a detail of a portion of the hood with semicircular cross section, according to one embodiment of the invention.

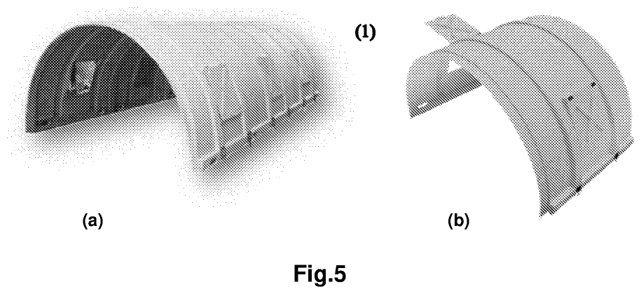

FIG. 6 shows a top perspective view of the hood disposed on the conveyor belt structure in operation, with part of the hood open, according to one embodiment of the invention.

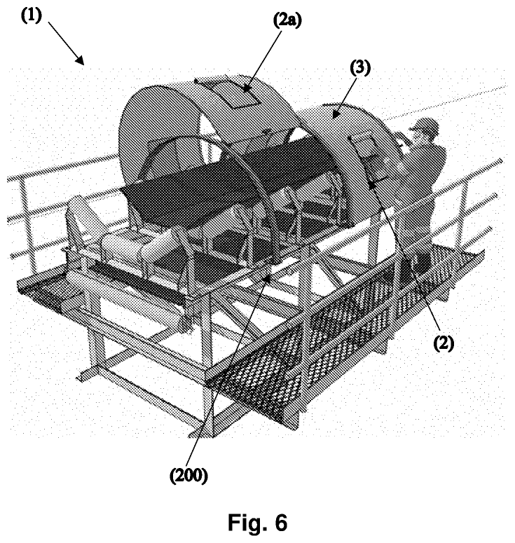

FIG. 7 shows a top perspective view of a hood assembly, according to one embodiment of the invention.

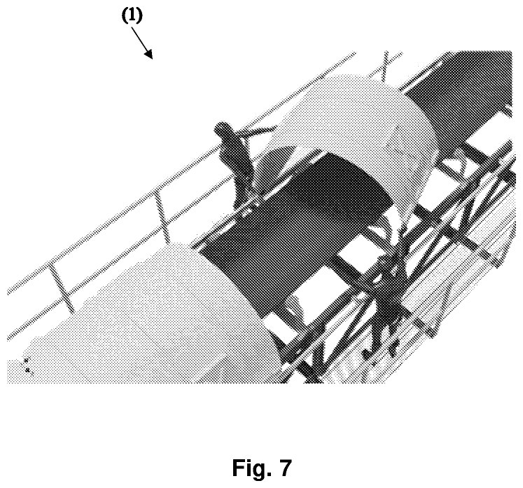

FIG. 8 shows a top perspective view of the hood disposed over the conveyor belt structure in operation and of the fastening system according to one embodiment of the invention.

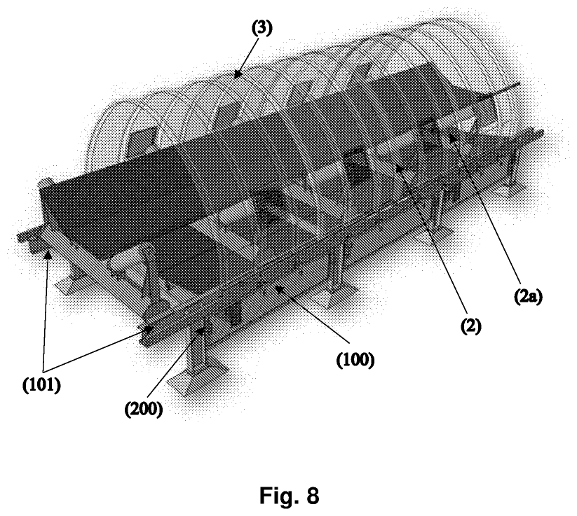

FIG. 9 shows a perspective view of the beam for vertical/horizontal fastening, according to one embodiment of the invention.

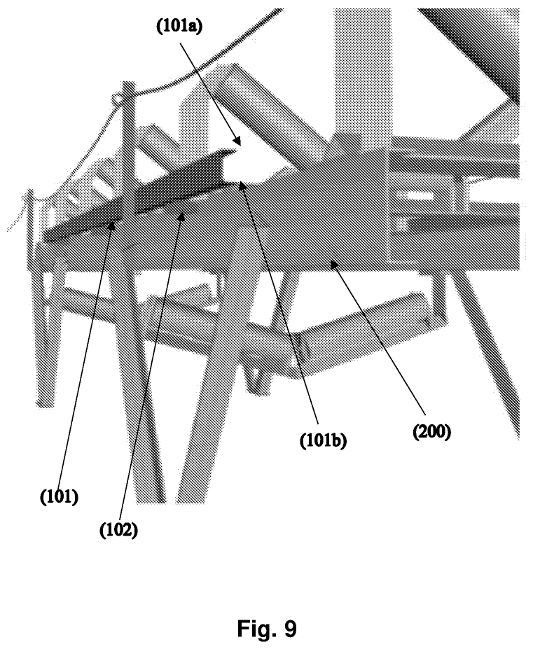

FIG. 10 shows a cross-sectional view of the hood and the fastening system, according to one embodiment of the invention.

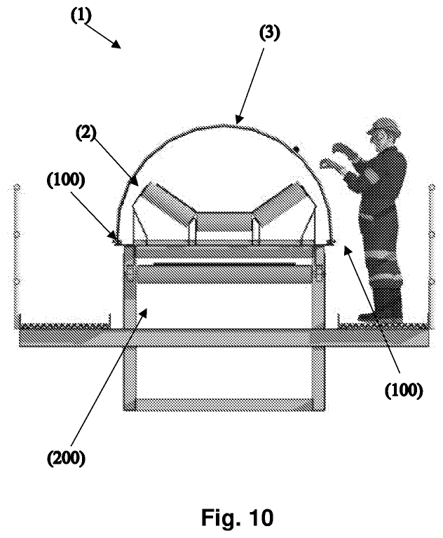

FIG. 11 shows a detail view of the fastening system, according to one embodiment of the invention.

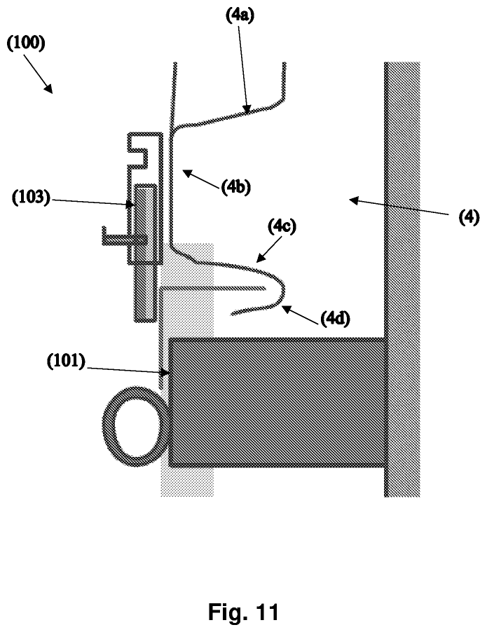

### DETAILED DESCRIPTION OF THE INVENTION

This utility model is related to a hood or cover (1) for conveyor belts comprising a quick-drive fastening system (100) which takes advantage of the strength and elasticity of the hood material achieved by the manufacturing technique.

The hood (1) has a preferably concave structure, comprising side walls (2) and a roof (3), arranged on a conveyor belt structure (200), with the opening facing downward. The hood (1) may comprise a semi-circular cross section or a section with flat side walls (2) and a curved roof (3). In one embodiment of the invention, the hood comprises windows (2a) in the side walls, for carrying out inspection processes. A folding portion (4) is configured at the ends of the hood (1). The folding portion (4) comprises a first portion (4a) extending outwardly, a second portion (4b) extending preferably vertically downwardly, a third portion (4c) extending inwardly and a fourth portion (4d) extending outwardly, wherein the fourth portion (4d) is shorter than the third portion (4c).

The fastening system (100) is designed to operate as a quick drive, which can take advantage of the strength and elasticity of the material, based on a longitudinal female-male fastening and a vertical/horizontal fastening. Said fastening system (100) is arranged on both sides of the conveyor belt structure (200). Thus, on each side of the structure (200), is arranged a longitudinal female-male fastening and a vertical/horizontal fastening.

The vertical/horizontal fastening prevents vertical and horizontal movements in the cross-sectional direction of the conveyor belt structure. The vertical/horizontal fastening comprises a rail (101), which is arranged longitudinally on each side of the structure (200). In one embodiment of the invention, said rail (101) corresponds to a beam with section C, wherein the open side is disposed towards the structure (200) of the conveyor belt, and wherein an upper portion (101a) of the rail (101) is shorter than the lower portion (101b). Each rail (101) is supported by a plurality of brackets (102), which are attached to the structure (200). In a preferred embodiment, the attachment of the brackets (102) to the structure (200) is by welding. In one embodiment of the invention, the brackets (102) are at least three brackets. In one embodiment of the invention, the brackets (102) are metal profiles. Preferably, the length of the rail (101) is greater than the longitudinal length of the hood (1). The upper portion (101a) of the rail (101) should be aligned with the conveyor belt table.

In this way, the area comprising the third portion (4c) and the fourth portion (4d) of the folding portion (4) of the hood (1) engages with the upper portion of the rail (101a), thus allowing vertical/horizontal fastening. In one embodiment of the invention, this type of fastening is carried out by pressure, taking advantage of the elastic properties of the material comprising the hood (1).

The female-male longitudinal fastening comprises a plurality of latches (103) arranged on the folding portion (4) of the hood (1), in particular, on the second folding portion (4b). In a preferred embodiment of the invention, the number of latches (103) is at least two per side. In order to carry out the fastening, the latches (103) are lowered to prevent the hood going inwards in the event that someone leans on it, thus connecting the hood (1) with the corresponding rail (101).

As for the fastening between hoods (1), these are overlapped by means of a female-male flange. The flange that remains on the lower part has a small concavity that allows channeling water in case of rain or during washing.

1. A fastening system for a hood for protecting conveyor belts, which takes advantage of the strength and elasticity of the hood material for attachment to a conveyor belt structure, comprising:
a) a hood comprising hood ends configured by a folding portion;
b) a vertical/horizontal fastening comprising a rail, which is arranged longitudinally on each side of the structure, which engages with the folding portion of the end of the cover; and
c) a fastening comprising a plurality of latches arranged on the folding portion of the hood, for the fastening thereof to the rail.

2. The fastening system according to claim 1, wherein the folding portion comprises a first portion extending outwardly, a second portion extending preferably vertically downwardly, a third portion extending inwardly and a fourth portion extending outwardly, wherein the fourth portion is shorter than the third portion.

3. The fastening system according to claim 1, wherein it is arranged on both sides of the structure of the conveyor belt.

4. The fastening system according to claim 2, wherein the rail corresponds to a C-section beam, wherein the open side is disposed towards the structure of the conveyor belt, and wherein an upper portion of the rail is shorter than a lower portion.

5. The fastening system according to claim 4, wherein each rail is supported by a plurality of brackets, which are attached to the structure.

6. The fastening system according to claim 5, wherein the fastening of the brackets to the structure is by welding.

7. The fastening system according to claim 6, wherein the brackets are at least three brackets.

8. The fastening system according to claim 7, CHARACTERIZED in that, wherein the brackets are metal profiles.

9. The fastening system according to claim 1, wherein the length of the rail is greater than the longitudinal length of the hood.

10. The fastening system according to claim 4, wherein the engagement between the rail and the folding portion occurs in an area comprising the third portion and the fourth portion of the folding portion of the hood.

11. The fastening system according to claim 2, wherein it is arranged on both sides of the structure of the conveyor belt.

12. The fastening system according to claim 3, wherein the rail corresponds to a C-section beam, wherein the open side is disposed towards the structure of the conveyor belt, and wherein an upper portion of the rail is shorter than a lower portion.

13. The fastening system according to claim 2, wherein the length of the rail is greater than the longitudinal length of the hood.

14. The fastening system according to claim 3, wherein the length of the rail is greater than the longitudinal length of the hood.

15. The fastening system according to claim 4, wherein the length of the rail is greater than the longitudinal length of the hood.

16. The fastening system according to claim 5, wherein the length of the rail is greater than the longitudinal length of the hood.

17. The fastening system according to claim 6, wherein the length of the rail is greater than the longitudinal length of the hood.

18. The fastening system according to claim 7, wherein the length of the rail is greater than the longitudinal length of the hood.

19. The fastening system according to claim 8, wherein the length of the rail is greater than the longitudinal length of the hood.
